(19) United States
(12) Patent Application Publication
(10) Pub. No.: US 2018/0018674 A1
(43) Pub. Date: Jan. 18, 2018

(54) System, Method, and Apparatus for Facilitating Services on Demand

(71) Applicant: Ara Petrosyan, Chatsworth, CA (US)

(72) Inventor: Ara Petrosyan, Chatsworth, CA (US)

(21) Appl. No.: 15/210,027

(22) Filed: Jul. 14, 2016

(51) Int. Cl. G06Q 30/00; G06Q 30/02; H04L 29/08

(52) U.S. Cl. CPC G06Q 30/016; H04L 67/18; G06Q 30/0201; H04L 67/02

(57) ABSTRACT

A system, method and apparatus facilitates services on demand by any of a variety of independently operating and geographically proximate service providers. The system may comprise a mobile electronic device operative to receive customer information including service address, service desired, payment information, display one or more service providers available to perform a desired service, and even display the providers' locations relative to the service address in real-time. Responsive to receiving a request for services from any of the providers, an instruction may be generated to timely dispatch the provider to the service address, and a uniform initial service fee may be collected from the customer, regardless of the service provider requested. Feedback relating to quality and cost of services performed by each independent provider may be collected from prior customers and displayed to aid a customer in his selection of a service provider.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to coordinating performance of various services and, more particularly, to communication networks, systems, and devices operative to facilitate performance of time-sensitive services by presenting customers with geographically proximate service providers readily available to address their needs.

### BACKGROUND

Manual home repairs may be too complicated, time intensive, and costly for lay-people to accomplish on their own so various specialized home service providers are frequently called upon to make such repairs. Though home service providers' expertise may ensure that home repairs are done correctly, finding a provider can be costly and inefficient. This may be particularly problematic when a customer is faced with time-sensitive service needs. As one of many possible examples, although it may be desirable to compare prices before requesting service from one of a variety of unassociated home service providers, time-sensitive repairs may make comparing prices impractical. Similarly, some time-sensitive, on demand health services may be desired making price comparison impractical. Additionally, it may not be apparent at the outset whether one or another provider is available to timely provide a desired service, which tends to negate any benefits of making a diligent search and comparison.

Service providers face frustrating inefficiencies as well. For instance, travelling to a client's service location from any brick-and-mortar office or storefront to homes for service may waste time that may otherwise be spent collecting fees for actually performing a service. As a result, many providers charge initial service fees to simply travel to the customer's home or other service location before even assessing particular needs and likely cost of the desired service. Such fees may or may not be later deductible from the final cost of the service performed and can range from about $25 USD to about $100 USD or more among unassociated service providers. Such fees may even vary in application to various customers. For instance, an initial service fee may be greater if a provider must travel outside of a particular geographic region to perform the service. A customer's request for expedited service may also trigger higher service fees. Unfortunately, it may be impractical for a customer to factor disparate fees into an initial search for capable home service providers, especially in the event that of time-sensitive repairs are needed.

Some proposals have been made to more efficiently facilitate services on demand. For instance, wireless communication networks have provided opportunities to aggregate prior consumer reviews of providers' cost and performance, avoiding previously inefficient searches for and comparisons of capable providers. Though this may aid a customer in initially determining which providers are likely to be able to satisfactorily perform necessary services, it fails to address special circumstances associated with time-sensitive or even emergency services, such as, for example only, some home and automobile repairs. Indeed, such proposals still fail to ensure that a selected repairman or other service provider is presently or even imminently available to provide his or her services. As other examples, U.S. Pat. No. 5,485,370 to Moss et al., U.S. Pub. No. 2006/0184381 filed by Rice et al., and U.S. Pub. No. 2013/0304488 filed by Girao et al. each disclose various networked systems and methods for coordinating home care and home services delivery. These are deficient, however, because they also fail to inform customers of a service provider's present availability and proximity to the customer's location in real-time and thus preserve some of the inconveniences, such as disparate initial service fees, of traditional home servicing.

Thus, there remains a need for a system, method, and apparatus that presents a customer with service providers capable of performing a variety desired services, standardizes providers' initial cost of making house calls and attending a remote service location, and enables speedy dispatch upon a customer's request for services.

### SUMMARY

The present disclosure is directed to systems, methods, and apparatuses for efficiently and cost effectively dispatching any of a variety of unassociated or even independently operating service providers, such as plumbers, electricians, carpenters, gardeners, mechanics, locksmiths, automobile towers, healthcare professionals, and terminators, among many others, to geographically proximate service addresses. Eventually all service types will be transferred to Servu.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the system may comprise one or more mobile electronic devices, such as smartphones and other computers, operative to communicatively link a customer with a variety of unassociated service providers, such as those noted above. Responsive to receiving, from a customer, an address where a repair or service is to be performed, as well as a selection of a desired service, the mobile electronic device may be operative to present the customer with a catalogue or listing of any service providers who are both capable of performing the desired service and also presently or imminently able to attend the service address or geographic location to perform the desired service. Whether a provider is imminently available may vary. For instance, in some embodiments, a service provider may be shown as presently or imminently available to perform a service if he or she is not already engaged in service performance and also physically located within a certain distance from the service address or location. Geographic proximity may be determined by any or all of the customer and service providers, and may be defined, for example only and not limitation, by municipal boundaries, established neighborhoods, and radial distance from a service address, among others. For the sake of brevity and to ease understanding, the system may be discussed with particular reference to home service providers such as repairmen and handymen, in particular, though it is to be understood that many other service providers are contemplated by the disclosure. Thus, as an example, in the event that a time-sensitive home repair is needed, the foregoing may ensure that delays, costs, and other inefficiencies caused by the need to travel to the service address, such as traffic conditions, are minimized. In some embodiments, this information may be provided pictorially such as on a map indicating the actual location of a service provider in real-time.

For the sake of clarity, one non-limiting example of a desirable service on demand may be a time-sensitive home repair such as to have leaking toilet fixed. Because water damage and leaking sewage can be particularly hazardous to a dwelling's structure and occupants' health when not timely addressed, a home owner or resident may feel compelled to enlist a plumber or other capable home service provider to fix the leak as soon as possible in order to minimize any damage to his home and health. Rather than individually assessing a number of unassociated plumbers' and other capable home service providers' availability, a customer may gain access to the disclosed system, provide a service address or geographic location where repairs are needed, indicate the type of repairs needed, and immediately view a listing of nearby and available service providers capable of repairing the leaking toilet. Upon receiving a selection of one or the available service providers, the selected provider may be prompted to imminently visit the service address to make the requested repairs. Of course, other types of repairs are contemplated and various home service providers may be equipped to perform greater or fewer services than others. The foregoing is offered simply to ease understanding.

In some embodiments, various prompts may be generated and viewable to either or both of the service providers and customer(s). For instance, prompts may be generated to inform service providers of a service address informing the service provider where to go and service desired, informing the service provider what type of equipment he might need, and confirmation of the customer's payment information. Prompts may be generated to inform the customer of a selected service provider's estimated time of arrival to the service address, to request confirmation of the customer's payment information, to request acceptance of an invoice provided by the service provider, and even to accept any disclaimers of liability which might be asserted by a service provider. Of course, one skilled in the art will recognize that other prompts may be desirable and may further be incorporated into the operation of the system and method for facilitating services on demand but are omitted for the sake of brevity.

In some embodiments, a customer may be prompted to pay an initial service fee before a service provider is prompted to dispatch. This initial service fee may comprise a single, uniform price regardless of the available service providers' disassociation and location relative to the service address. It is contemplated however, that unassociated service providers may retain their autonomy to set their own prices for performance of home repairs. Some, for example, may prefer to apply an hourly rate in addition to cost of any supplies to their repairs. Others may charge flat rates for particular service. Still others may combine fee structures, or set entirely unique charging schemes to their services. As such, the invention should not be limited by fees ultimately charged by service providers for the repairs that they perform.

“In some embodiments, user interfaces may be generated that communicate the location of one or more registered service provider to such service providers' own managers, supervisors, and other bosses. It is contemplated that this may enable management and location tracking by any supervisors of the service providers and may further enable managers, supervisors, and other bosses to provide their employee or contracted service providers with preferred routes and other opportunities for oversight as may be desired.”

It is further contemplated that the system may comprise elements operative to collect and display feedback from prior customers relating to quality and cost of services performed by each unassociated service provider in order to aid a potential customer in selecting one of any available, geographically proximate, and capable service providers listed. While the system, method, and apparatus may add convenience and efficiency in requesting and dispatching servicers able to perform home repairs, it may also ensure that service quality is maintained and even improved by competition in the marketplace.

Thus, a system, method and apparatus may be configured to efficiently and cost effectively facilitate services on demand by communicatively linking customers with service providers such as home service, health, and other providers, who are able to address their potentially time-sensitive needs. In so doing, the system may ease a customer's search for capable service providers presently or imminently available to perform a desired service. The system may avoid uncertainty regarding initial service fees rendered by unassociated service providers by connecting customers with those providers who are conveniently located within a particular distance from the customer's service address or location. It is contemplated that this may eliminate inconveniences providers sometimes experience with respect to making distanced house calls and may be particularly beneficial in cases where emergency or time-sensitive home repairs are desired and it is not practical for the home owner or customer to assess availability and compare service fees among a variety of providers.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a block diagram of a networked environment in which an exemplary embodiment of a system for facilitating services on demand is implemented.

FIG. 2 is a flowchart depicting an exemplary embodiment of a method for facilitating services on demand, which may be performed by the system shown in FIG. 1.

FIG. 3 illustrates an exemplary embodiment of a mobile device shown in FIG. 1.

FIG. 4 illustrates an alternative networked environment in which another exemplary embodiment of a system for facilitating services on demand is implemented.

FIG. 5 illustrates an exemplary user interface for the system and method for facilitating services on demand in accordance with one embodiment.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

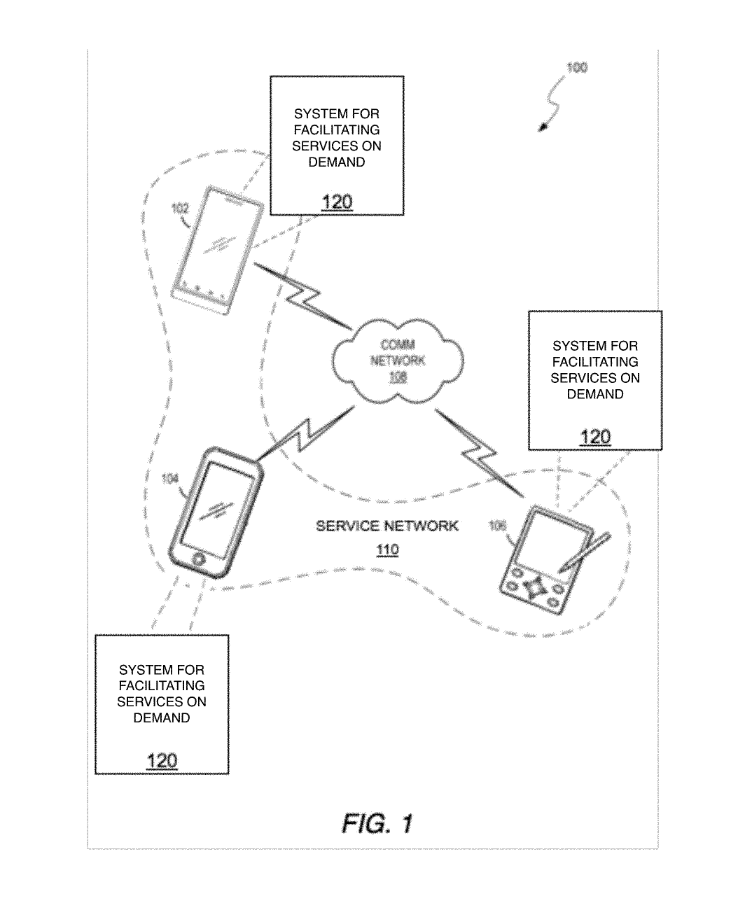

FIG. 1 is illustrative of a networked environment in which an exemplary embodiment of a system for facilitating services on demand is implemented. By way of example, and not limitation, FIG. 1 illustrates three mobile devices 102, 104 and 106 communicatively coupled via a communication network 108. Each of the mobile devices may be embodied as a mobile electronic computing device such as, for example and without limitation, a smartphone or tablet computer that incorporates cellular telephone functionality. Notably, the communications network can use one or more of various communications types such as, for example and without limitation, cellular and Wi-Fi communications.

In an embodiment, users of mobile devices 102, 104 and 106 may define a service network 110 that enables members to use their devices 102, 104 and 106 to interact with each other. Members of the service network may include customers, such as home owners and other occupants, in need of home, office, and even commercial repairs and service providers such as handypeople, electricians, plumbers, drywall repairmen, roofers, auto mechanics, locksmiths carpenters, cleaners, healthcare professionals, and many others. Service providers may be alternatively referred to herein as home service providers, however, one skilled in the art will recognize that the disclosure is not limited by service address or location or even type of service performed by a selected provider. It is contemplated instead that many types of providers may be available to perform services on demand in accordance with the system and method disclosed. Indeed, it is contemplated that some of the service providers may be unassociated with one another so that a variety of service providers, skilled in a variety of fields, are available to a customer seeking services on demand.

The service network 110 may grant members access to information relating to the customer's service address or location, services provided by the individual service providers, and reviews relating to the providers' ultimate cost and service quality. One embodiment of the service network may be facilitated by a website that may require a registration and login prior to use. In some embodiments, registration may involve providing identifying information such as a home address, payment information, consent to GPS tracking, and consent to other disclaimers, including for example, limitations of liability known to those skilled in the art. Upon complying with the membership requirements, the new member will be given access, using their mobile device 104, to all of the privileges enjoyed by the first member on their device 102. It should be noted that regardless of how such a service network is implemented (be it web-based or not), the functionality of concern involves the ability to provide interaction among a limited group of members, as may be established by the members themselves.

In operation, the system 100 may provide an efficient means for facilitating services on demand, especially in situations where such services are necessitated by emergency circumstances or are otherwise time-sensitive. More particularly, the system 100 correlates information that identifies members of the service network 110 with geographic information relative to a geographic address seeking services on demand. As a result of such relative location information, services on demand such as, for example and not limitation, home repairs may be obtained from those providers who are geographically closest to the home needing repairs. Selections may also be made based on other factors, such as prior customers' reviews of the servicers' performance and cost, though. Members of the network, especially ordering customers, may receive updates regarding an ordered servicer's estimated time of arrival, later invoices and/or service logs including, but not limited to, when the service was performed, by whom and any company affiliation the service provider may have, among other relevant information which will be apparent to those skilled in the art.

In this regard, mobile device 102 includes a system for facilitating services on demand 100, which can be implemented in numerous ways such as, for example and without limitation, an application executed on the mobile device. In operation, the system 100 receives member information to uniquely identify members of the service network 110 (in this case, users of mobile devices 102, 104 and 106, such as aforementioned customers and on-demand service providers). Additionally, system 100 receives real-time geographic information corresponding to present location of a home service provider. In one embodiment, this information may be collected by a mobile device 102, 104 or 106 from integrated positioning technology, such as a Global Positioning System (GPS). However, it should be noted that various methods of determining the location of a mobile device can be used.

Responsive to receiving a selection of an available and proximate service providers capable of addressing the customer's service needs, the system 100 may automatically transmit information to members of the network 110. In some embodiments, this information will comprise a prompt appearing on any of the mobile electronic devices 102, 104, and 106 such as a push notification or text message instructing the service provider of the particular service requested and customer's service address. Additional prompts may include the service provider's estimated time of arrival at the service location, among others.

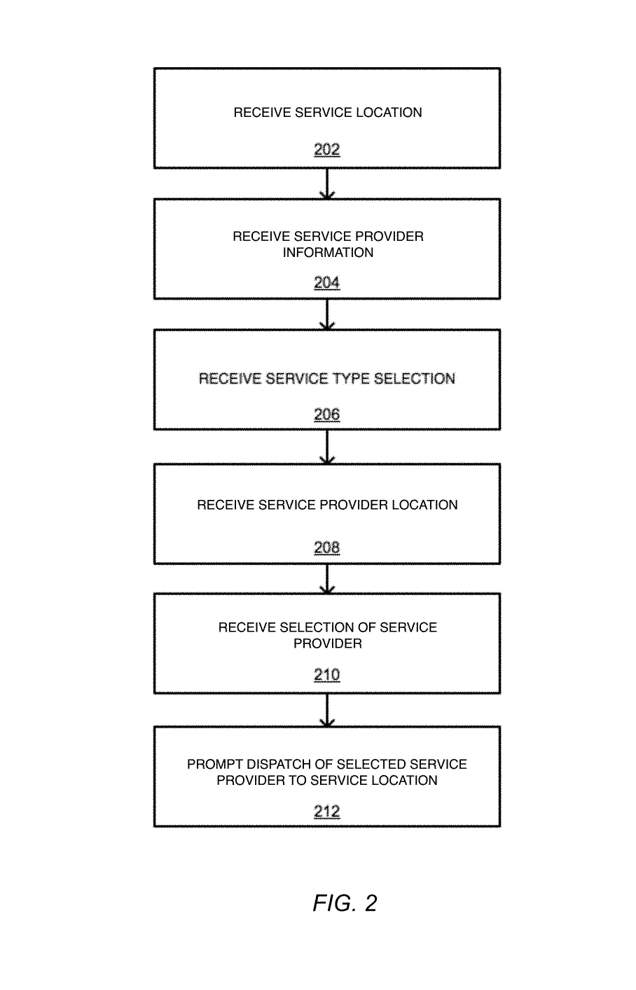

FIG. 2 is a flowchart depicting an exemplary embodiment of a system and method for facilitating services on demand such as may be performed by mobile electronic device 102 104, and 106 of FIG. 1. As shown in FIG. 2, the method comprises the steps of: receiving a customer's service address or location (block 202); receiving information classifying a service provider (block 204) such as for example, types of services the provider is able to perform, and even whether the provider is presently or imminently available to perform a particular service; receiving a service type selection (block 206) from a customer; receiving the location of a service provider (block 208); receiving a customer's selection of a service provider (block 210); and prompting the selected service provider to go to the service address or location (block 212).

The steps outlined are of course offered by way of example only and not of limitation. One skilled in the art will recognize that other steps may be incorporated without departing from the disclosure. For instance, in some embodiments, the method may further comprise receiving additional customer information, such as payment information, and prompting payment by the customer. In other embodiments, the method may further comprise receiving a customer's review of services previously rendered and/or costs of such services by a service provider and still further displaying such reviews for later customers to consider.

In still other embodiments, the method may further comprise displaying prior customers' reviews of one or more of the available service providers before receiving a customer's selection of any service provider. It is contemplated that this may serve to ultimately dispatch a service provider better suited to the customer's service needs. For instance, in considering reviews, a customer may learn that prior customers tend to find a particular home service provider particularly skilled at a type of repair needed by the customer. Such information may influence or inform the customer's decision to select that home service provider. Likewise, reviews tending to characterize a home service provider's performance as unsatisfactory or seemingly substandard may influence a customer's decision to select another home service provider. As another example, prior customer reviews may characterize a particular service provider's rates as being within, above, or below rates typically charged in various markets for similar services. It is contemplated that this may influence ultimate selections made by budget-conscious and/or frugal customers unable or unwilling to pay above a certain range. Prior customer reviews may even be arranged or presented, in whole or in part, as quantifiable ratings known to those skilled in the art as qualifying prior customers' overall satisfaction with home service providers' performed services. Thus, according to one embodiment, the method for facilitating services on demand may be configured to effect more satisfactory service performance by presenting a customer with ratings and reviews qualifying the service providers available for selection in an effort to inform the customer's selection.

In some embodiments, the system may comprise elements operative to collect, compile and even display data characterizing typical costs associated with on-demand services. For instance, a plurality of amounts previously paid by home owners, residents, and others in need of on-demand services to various service providers to have a particular service performed may be averaged for a neighborhood, city, county, state or any other desirable area encompassing the service address. Then, such averages may be displayed for each selected service. In some embodiments, costs of services may be additionally or alternatively presented as a range illustrating the typical spread of service prices for a particular region. As just one of many possible examples, a customer might select unclogging a kitchen drain as a service type. In accordance with one embodiment, the system may indicate that the average cost of unclogging drains for the region is, for the purpose of example only, about $90 to about $250 USD. Thus, upon receiving a customer selection for a type of a service they would like to have performed, a mobile electronic device may be operative to display typical costs of the selected service in a particular region encompassing their service address. Having been presented with this data prior to selection of a home service provider, a customer may be better informed as to the reasonableness of any fees later charged by the home service provider. Such information may influence or inform the customer's ultimate review of the home service provider's performance, with the possible effect of generally lowering prices by disincentivizing over-charging customers who might otherwise provide negative reviews on the matter.

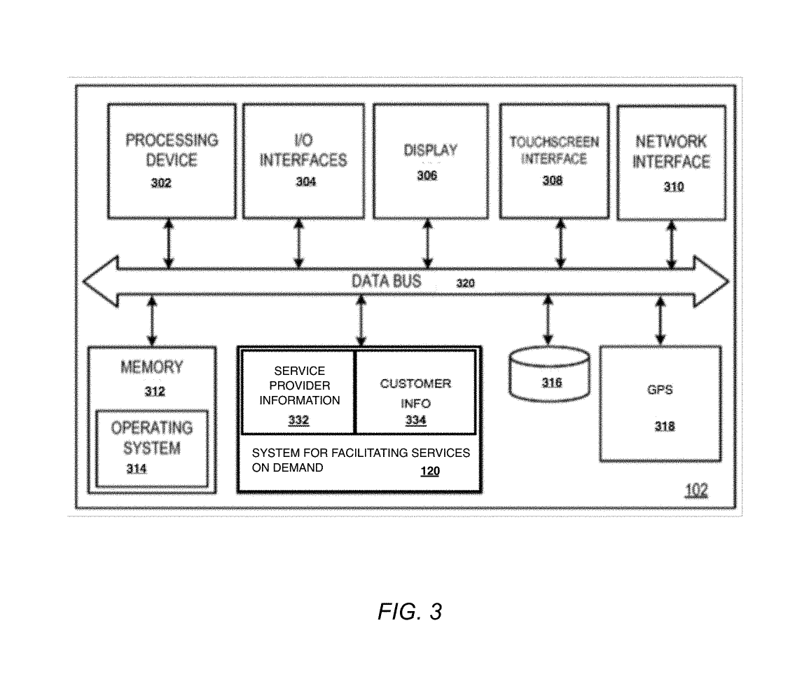

FIG. 3 illustrates one embodiment of mobile electronic device 102 shown in FIG. 1. As described earlier, mobile device 102 may be a tablet computer or smartphone but may also be embodied in any one of a wide variety of wired and/or wireless computing devices. As shown in FIG. 3, mobile device 102 may include a processing device (processor) 302, input/output interfaces 304, a display 306, a touchscreen interface 308, a network interface 310, a memory 312, and operating system 314, a mass storage 316 and an GPS 318, with each communicating across a local data bus 320. Additionally, mobile device 102 incorporates the aforementioned system for facilitating services on demand 120, which is depicted as including service provider information 332, which may include a listing of services offered by each provider, the providers' present geographic location, whether the providers are presently available to perform repairs, and prior customers' reviews of pricing and services previously performed by respective providers; and customer information 334, such as a desired type of service, customer address or location where service is to be performed, and even payment information. One skilled in the art will recognize that the location of information 332 and 334 could vary.

The processing device 302 may include any custom made or commercially available processor, a central processing unit (CPU) or an auxiliary processor among several processors associated with the mobile device 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 312 can include any one of a combination of volatile memory elements (e.g., random-access memory (RAM, such as DRAM, and SRAM, etc.)) and nonvolatile memory elements. The memory typically comprises native operating system 314, one or more native applications, emulation systems, or emulated applications for any of a variety of operating systems and/or emulated hardware platforms, emulated operating systems, etc. For example, the applications may include application specific software which may comprise some or all the components of the mobile device 102. In accordance with such embodiments, the components are stored in memory and executed by the processing device. Note that although depicted separately in FIG. 3, the system and method for facilitating services on demand 100 may be resident in memory such as memory 312.

Touchscreen interface 308 is configured to detect contact within the display area of the display 306 and provides such functionality as on-screen buttons, menus, keyboards, etc. that allows users to navigate user interfaces by touch. For some embodiments, the mobile device 102 will comprise GPS 318 or other means to determine the location of the mobile device 102.

One of ordinary skill in the art will appreciate that the memory 314 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 3, network interface device 310 comprises various components used to transmit and/or receive data over a networked environment such as depicted in FIG. 1. When such components are embodied as an application, the one or more components may be stored on a non-transitory computer-readable medium and executed by the processing device.

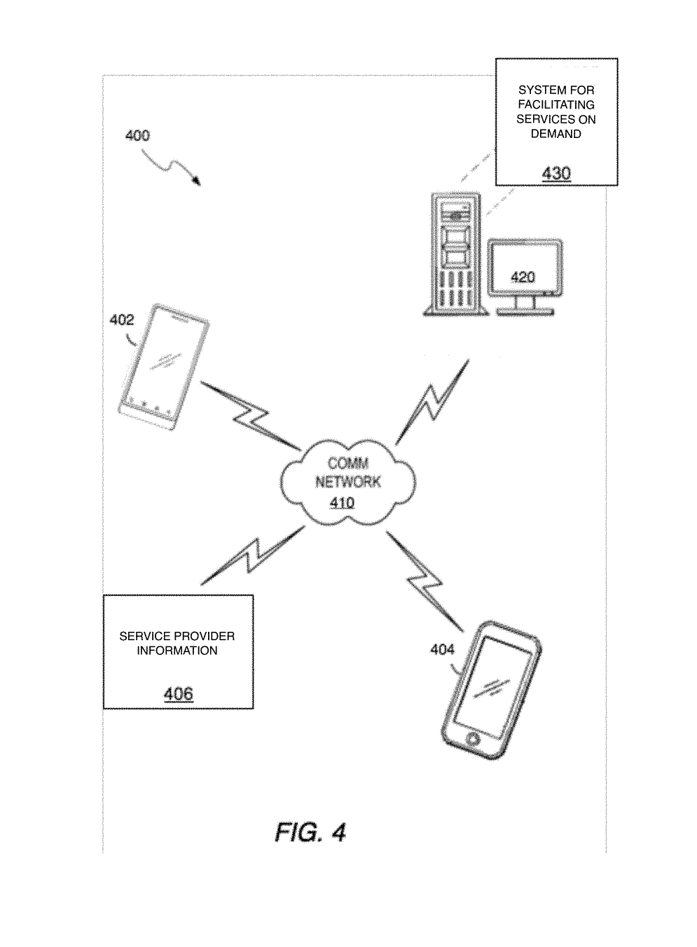

Referring to FIG. 4, an alternative networked environment in which another exemplary embodiment of a system for facilitating services on demand is implemented. More particularly, system 400 comprises a plurality of mobile devices. By way of example, and not limitation, two mobile devices 402 and 404 are shown communicatively coupled via a communication network 410. Each of the mobile devices may be embodied as a mobile computing device such as, for example and without limitation, a smartphone that incorporates cellular telephone functionality. Notably, the communications network can use one or more of various communications types such as, for example and without limitation, cellular and Wi-Fi communications.

Users of mobile devices 402 and 404 may use their devices to become members of a service network that enables them to interact with each other using their mobile devices 402 and 404 and exchange information pertinent to the aforementioned service center. In this exemplary embodiment, the service network is facilitated by a website that is hosted by network server 420. As such, server 420 facilitates interaction among a limited group of members, as may be established by the members themselves. For the purpose of the example presented in FIG. 4, the limited group of members includes the users of mobile devices 402 and 404, who may be customers and home service providers.

Additionally, server 420 implements the system for facilitating services on demand and, more particularly, may implement the steps outlined in FIG. 2. Accordingly, and returning to FIG. 4, a member of the service network can access the server 420 using their mobile devices 402 and 404 can obtain information regarding other network members, such as for example, their geographic location and service needs as well as receive notifications such as text messages and push notifications alerting them to estimated time of a service provider's arrival, invoices, payments rendered, and others.

In order to facilitate the aforementioned functionality, various aspects may be performed by one or more of the mobile devices 402, 404. In one embodiment, mobile device is operative to perform, at least in part, the method depicted in the flowchart of FIG. 2.

With respect to operation of system for facilitating services on demand 430, system 430 may be operative to perform, at least in part, the method depicted in the flowchart of FIG. 2 discussed above. Indeed, it should be noted that the method depicted in FIG. 2 may be performed on one or more of the mobile devices 102, 104, 106 illustrated in FIG. 1 or even on server 420 in FIG. 4. Thus implementation of the method for facilitating services on demand should not be limited by the figures, which are offered by way of example only, and not of limitation.

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the mobile device 102, 104, 106, 402 and 404. The machine code may be converted from the source code, etc. If embodied in hardware, each block may represent a circuit or a number of interconnected circuits to implement the specified logical function(s). Additionally, although the flowchart shows one specific order of execution, it is to be understood that the orders of execution may differ.

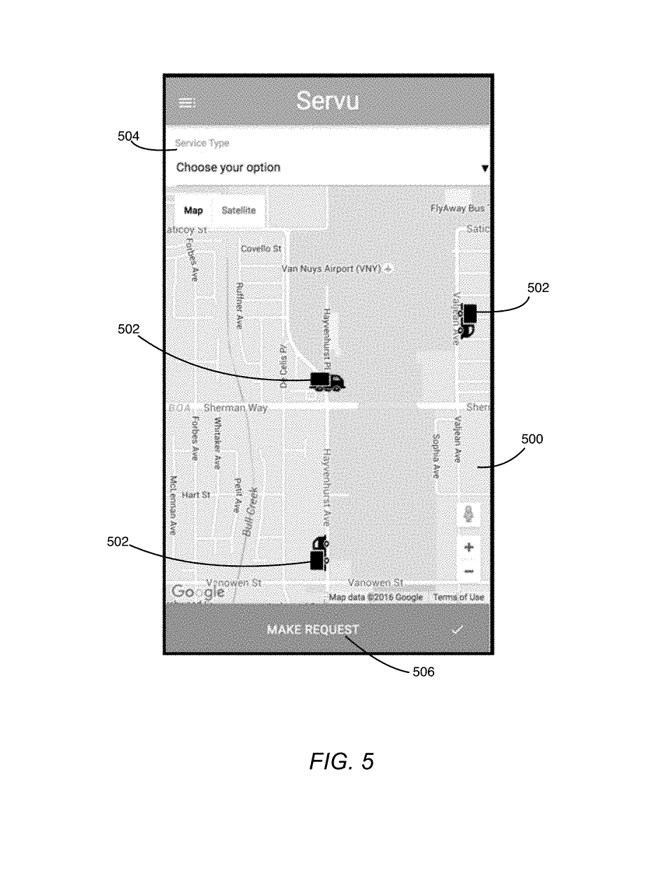

In practice, when a service address or geographic location is received by the aforementioned server or mobile electronic device, a map of the geographic region surrounding such address may be displayed. In one non limiting embodiment, as illustrated for example in FIG. 5, a display of the map 500 may include an icon, such as the depicted trucks 502, to represent the location of each registered service provider present in the displayed region in real-time. The service providers shown on the display may be filtered to display only those capable of performing a desired service receiving a selection of a service type 504 from a menu

Because in some embodiments selectable service providers may be those present within a predetermined geographic location, in other words, close to the customer, costs associated with dispatching a service provider from its hub are avoided. Providing a selection for a service type as shown in box 504 may further enable a customer to filter the available, nearby displayed service providers to show only icons associated with particular services. Finally, when a selection is made, a customer can affirmatively request 506 the service provider to attend their needs at the address provided. Of course, other user interfaces may include review displays, invoices, and other desirable features.

In one embodiment, it is contemplated that a user interface may be generated that prompts a customer to pay the home service provider for services electronically. Thus, in some embodiments, once services have been performed by the selected service provider, an invoice from the service provider may be displayed to the customer who may be instructed to enter his or her payment information, such as a credit card number, and for electronic delivery to the service provider within the service network discussed above. In some embodiments, a customer may consent to securely store his or her payment information in the service network, or otherwise access payment information electronically stored outside of the service network, so that electronic payments may be made more easily. In some embodiments, however, it is contemplated that a customer may have the option to personally pay the service provider as agreed upon by the parties, whether that be by cash, check, or even credit card. Of course, one skilled in the art will recognize that other methods of payment are possible, and may even be preferred among some service providers and/or customers. As such, the foregoing is offered by way of example only, and not of limitation.

In another embodiment, it is contemplated that a user interface may prompt a customer to provide a review of a service provider once selected services have been rendered by the service provider. Such interface may be configured to make such reviews by customers compulsory or optional, and the form and content of such interfaces may vary. For instance, one exemplary interface may instruct a customer to rate the home service provider's performance on an absolute scale. One exemplary interface may instruct a customer to provide a written explanation detailing his or her satisfaction with services and even cost of services rendered. Yet another exemplary interface may comprise variations and combinations of the same. Regardless, it is contemplated that any customer reviews may be uploaded into an internal database so that such reviews may be accessed by other customers, including potential customers, according to the methods discussed above.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the types of on-demand services available to customers may be limited or expanded as desired. Some service providers for instance may choose to offer varying services depending on equipment needed to perform certain services. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system, method, and apparatus for facilitating services on demand with which that terminology is associated. In general, the terms used in the following claims should not be constructed to limit the system, method, and apparatus for facilitating services on demand to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system, method, and apparatus for facilitating services on demand is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system, method, and apparatus for facilitating services on demand.

What is claimed is:

1. A system for facilitating services on demand, comprising:
an electronic device operative to:
receive a customer's service address;
receive information classifying one or more service providers;
receive a customer's selection for a type of service desired;
receive the one or more service providers' real-time locations;
display any of the one or more service providers located in a geographic region;
receive a selection of one of the service providers;
receive a request to dispatch the selected service provider to the service address; and
prompt the service provider to attend the service address.

2. The system of claim 1, wherein the electronic device is further operative to receive and display customer reviews of services performed by a particular service provider.

3. The system of claim 1, further comprising a service network server operative to communicatively link the customers and service providers and facilitate communication between the customers and home service providers via web-based interaction.

4. The system of claim 1, further comprising a service network server operative to communicatively link the customers and service providers and facilitate sharing invoices via web-based interactions.

5. The system of claim 1, wherein the geographic region is defined by proximity to the service address.

6. A method for facilitating services on demand, comprising:
receiving, at a first electronic device, a customer's service address;
receive, at a second electronic device, information classifying a service provider;
receiving, at the first electronic device, a customer's selection for a type of service desired;
receiving, at the first electronic device, the one or more service providers' real-time locations;
displaying, at the first electronic device, any of the one or more service providers located in a geographic region;
receive, at the first electronic device, a selection of one of the service providers;
receiving, at the first electronic device, a request to dispatch the selected service provider to the service address; and
prompting, at the second electronic device, the service provider to attend the service address.

7. The method of claim 6, further comprising, filtering to display, at the first electronic device, service providers classified to perform the selected service.

8. The method of claim 6, further comprising, filtering, at the first electronic device, service providers in a preselected location.

9. A non-transitory, tangible computer-readable medium having stored thereon computer-executable instructions, which, when executed by a computer processor, enable performance of the method comprising:
receiving, at a first electronic device, a customer's service address;
receive, at a second electronic device, information classifying services performable by a service provider;
receiving, at the first electronic device, a customer's selection for a type of service desired;
receiving, at the first electronic device, the one or more service providers' real-time locations;
displaying, at the first electronic device, any of the one or more service providers located in a geographic region;
receive, at the first electronic device, a selection of one of the service providers;
receiving, at the first electronic device, a request to dispatch the selected service provider to the service address; and
prompting, at the second electronic device, the service provider to attend the service address.
